(19) United States
(12) Patent Application Publication
(10) Pub. No.: US 2018/0011727 A1
(43) Pub. Date: Jan. 11, 2018

(54) VIRTUALIZATION SYSTEM, SERVER, TERMINAL, VIRTUALIZATION METHOD, AND PROGRAM RECORDING MEDIUM

(71) Applicant: NEC Corporation, Minato-ku, Tokyo (JP)

(72) Inventor: Junichi Higuchi, Tokyo (JP)

(73) Assignee: NEC Corporation, Minato-ku, Tokyo (JP)

(21) Appl. No.: 15/544,292

(22) PCT Filed: Jan. 15, 2016
(86) PCT No.: PCT/JP2016/000193

§ 371 Date: Jul. 18, 2017

(30) Foreign Application Priority Data
Jan. 27, 2015 (JP) 2015-013169

(51) Int. Cl. G06F 9/455; G06F 13/42; H04L 29/08

(52) U.S. Cl. CPC G06F 9/45558; G06F 13/4282; G06F 2009/45579; H04L 67/10; G06F 2009/45595

(57) ABSTRACT

[Problem] To enable a user to control a virtualization system without wasting resources. [Solution] A virtualization system containing an operation unit, an operation reporting unit, a message processing unit, and an operation processing unit. The operation unit outputs a signal on the basis of a user operation. The operation reporting unit transmits to a network an operation message generated by appending, to first operation information indicating the content of the operation corresponding to that signal, a header addressed to a server providing virtual machines. The message processing unit generates second operation information indicating that the operation indicated with the first operation information has been performed with respect to the virtual machine corresponding to the transmission source of that operation message. On the basis of the second operation information, the operation processing unit instructs the virtual machine corresponding to the transmission source to perform the action corresponding to that operation.

### TECHNICAL FIELD

The present invention relates to a technique of operating a virtual machine by a virtual machine user.

### BACKGROUND

There are known various related techniques for implementing virtual machine control by a virtual machine user.

Generally, power source control of a virtual machine is executed by a management server on which a management software of a virtualization software such as a hypervisor is operated. Normally, a management software is operated only by a system manager. Therefore, when a user of a virtual machine inadvertently shuts down a virtual machine, the user is required to ask a system manager to recover the virtual machine. Further, even when a user is allowed to use a management software, the user is required to connect a terminal (a physical terminal) of the user to a management server on which the management software is operated, and is required to perform setting change of the terminal.

PTL 1 describes a technique for solving the aforementioned problem. A virtual machine control system described in PTL 1 is a system including a virtualization OS (Operating System), and a virtualization environment management server, wherein a virtual machine is newly generated and control of a virtual environment is executed in a guest space for each user, from the guest space. Herein, the virtualization OS generates a guest space for each user, in which a plurality of virtual machines are connected by a VLAN (Virtual Local Area Network). Further, the virtualization environment management server executes generation and control of a virtual machine in a guest space through a management LAN (Local Area Network) connected to the virtualization OS. Control of the virtual environment is, for instance, ON/OFF of a power source of a generated virtual machine.

Further, the virtual machine control system described in PTL 1 includes a virtual machine control slave server and a virtual machine control master server. The virtual machine control slave server is connected to a VLAN in a guest space, receives, from a user, a change instruction on a virtual environment in the guest space, and stores the instruction in a virtual storage device in the guest space. The virtual machine control master server directly accesses the virtual storage device, acquires change instruction information on the virtual environment from the virtual storage device, and transmits the change instruction information to a virtualization environment management server through a management LAN to make a virtual environment instructed by the instruction information.

### CITATION LIST

### Patent Literature

[PTL 1] Japanese Laid-open Patent Publication No. 2011-192194

### SUMMARY OF INVENTION

### Technical Problem

In a virtualization system, it is required to minimize resources for use in managing/controlling the virtualization system, other than virtual machines to be used by virtual machine users.

However, in the aforementioned virtual machine control system described in PTL 1, there is a problem that the following resources are necessary for operation (control, such as ON/OFF of a power source) of a virtualization system. The resources are resources for use in implementing a virtualization environment management server, a virtual machine control slave server, and a virtual machine control master server.

One of exemplary objects of the present invention is to provide a virtualization system, a server, a terminal, a virtualization method, and a program therefor, that enable to solve the aforementioned problems.

### Solution to Problem

A virtualization system according to an aspect of the present invention includes:

operation means for outputting a signal, based on an operation of a user;

operation notifying means for transmitting, to a network, an operation message generated by appending a header addressed to a server configured to provide a virtual machine for first operation information indicating a content of the operation associated with the output signal;

message processing means for generating second operation information indicating that the operation is performed with respect to the virtual machine associated with a transmission source of the operation message, based on the operation message; and

operation processing means for instructing an action associated with the operation to the virtual machine associated with the transmission source, based on the second operation information.

A terminal according to an aspect of the present invention includes: operation means for outputting a signal, based on an operation of a user; and operation notifying means for transmitting, to a network, an operation message generated by appending a header addressed to a server configured to provide a virtual machine for first operation information indicating a content of the operation associated with the output signal, wherein

the server generates second operation information indicating that an operation indicated by the first operation information is performed with respect to the virtual machine associated with a transmission source of the operation message, based on the operation message, and instructs an action associated with the operation to the virtual machine associated with the transmission source, based on the second operation information.

A server according to an aspect of the present invention includes:

message processing means for generating second operation information indicating that an operation indicated by first operation information is performed with respect to a virtual machine associated with a terminal, based on an operation message to be transmitted by the terminal; and

operation processing means for instructing an action associated with the operation to the virtual machine associated with the terminal, based on the second operation information, wherein

the terminal transmits, to a network, an operation message generated by appending a header addressed to a server configured to provide the virtual machine for first operation information indicating a content of the operation associated with a signal to be output by an operation means, based on an operation of a user.

A virtualization method according to an aspect of the present invention includes:

outputting a signal, based on an operation of a user;

generating an operation message by appending a header addressed to a server configured to provide a virtual machine for first operation information indicating a content of the operation associated with the signal;

transmitting the operation message to a network;

generating second operation information indicating that the operation is performed with respect to the virtual machine associated with a transmission source of the operation message, based on the operation message; and

instructing an action associated with the operation to the virtual machine associated with the transmission source, based on the second operation information.

A first program recording medium according to an aspect of the present invention causes a computer to execute:

a process of generating an operation message by appending a header addressed to a server configured to provide a virtual machine for first operation information indicating a content of an operation of a user, associated with a signal output based on the operation; and

a process of transmitting the operation message to a network, wherein

the server generates second operation information indicating that the operation is performed with respect to the virtual machine associated with a transmission source of the operation message, based on the operation message, and instructs an action associated with the operation to the virtual machine associated with the transmission source, based on the second operation information.

A second program recording medium according to an aspect of the present invention causes a computer to execute:

a process of generating second operation information indicating that an operation indicated by first operation information is performed with respect to the virtual machine associated with a terminal, based on an operation message to be transmitted by the terminal; and

a process of instructing an action associated with the operation to the virtual machine associated with the terminal, based on the second operation information, wherein

the terminal generates an operation message by appending a header addressed to a server configured to provide the virtual machine for first operation information indicating a content of the operation associated with a signal to be output by an operation means, based on an operation of a user, and transmits the operation message to a network.

### Advantageous Effects of Invention

The present invention allows a user to control a virtualization system without wasting resources.

### BRIEF DESCRIPTION OF DRAWINGS

FIG. 1 is a block diagram illustrating a configuration of a virtualization system according to a first example embodiment of the present invention;

FIG. 2 is a block diagram illustrating a configuration of a remote terminal in the first example embodiment;

FIG. 3 is a block diagram illustrating a configuration of a server in the first example embodiment;

FIG. 4 is a diagram illustrating an example of an operation message in the first example embodiment;

FIG. 5 is a diagram illustrating an example of a server identifier in the first example embodiment;

FIG. 6 is a block diagram illustrating a hardware configuration of a computer configured to implement the virtualization system according to the first example embodiment;

FIG. 7 is a flowchart illustrating an operation of the virtualization system in the first example embodiment;

FIG. 8 is a block diagram illustrating a configuration of a virtualization system according to a second example embodiment of the present invention;

FIG. 9 is a block diagram illustrating a configuration of a remote terminal in the second example embodiment;

FIG. 10 is a block diagram illustrating a configuration of an interface card in the second example embodiment;

FIG. 11 is a block diagram illustrating a virtualization configuration of the virtualization system in the second example embodiment;

FIG. 12 is a diagram illustrating an example of a PCI bus tree of a server in the second example embodiment;

FIG. 13 is a diagram illustrating an example of a PCI bus tree of a virtual machine in the second example embodiment;

FIG. 14 is a block diagram illustrating a configuration of a virtualization software and a virtual machine in the second example embodiment;

FIG. 15 is a flowchart illustrating an operation of the remote terminal in the second example embodiment; and

FIG. 16 is a flowchart illustrating an operation of the server in the second example embodiment.

### DESCRIPTION OF EMBODIMENTS

In the following, example embodiments for implementing the present invention are described in detail with reference to the drawings. Note that in the drawings and in the example embodiments described herein, similar components are indicated with the same reference signs, and description thereof is omitted as necessary.

### First Example Embodiment

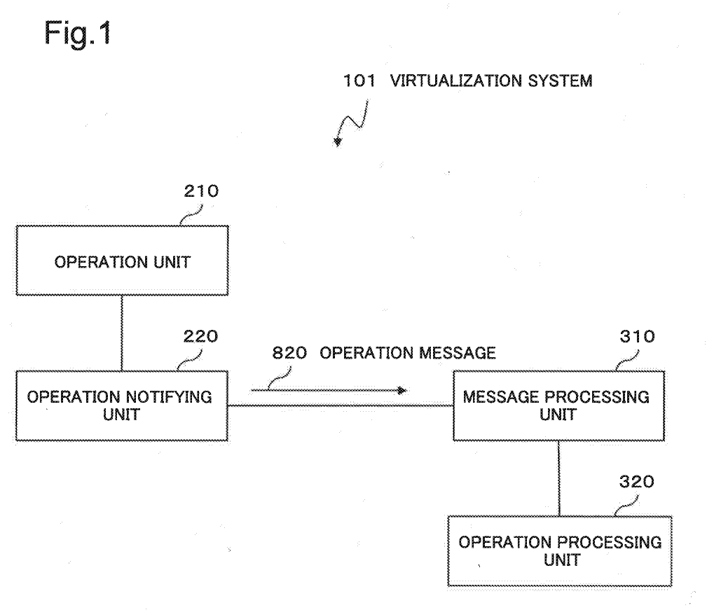

FIG. 1 is a block diagram illustrating a configuration of a virtualization system 101 according to the first example embodiment of the present invention. As illustrated in FIG. 1, the virtualization system 101 includes an operation unit (also referred to as an operation button or operation means) 210, an operation notifying unit 220, a message processing unit 310, and an operation processing unit 320. Note that the arrow illustrated in the block diagram of FIG. 1 indicates an example of an information flow. The direction of information flow is not limited to the direction of the arrow illustrated in FIG. 1.

Each component illustrated in FIG. 1 may be any of circuitry as a hardware unit, a module included in a microchip, or components divided as a functional unit of a computer device. In this example, description is made based on the premise that the components illustrated in FIG. 1 are components divided as functional units of a computer device.

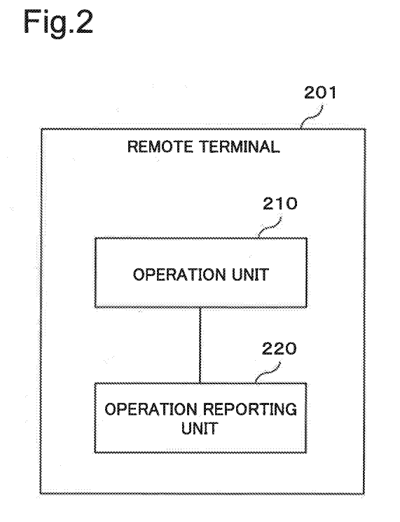

The operation unit 210 and the operation notifying unit 220 may be loaded in a terminal to be used by a user who uses a virtualization machine (not illustrated), for instance. FIG. 2 is a block diagram illustrating a configuration of a remote terminal 201, which is a terminal including the operation unit 210 and the operation notifying unit 220 in the example embodiment.

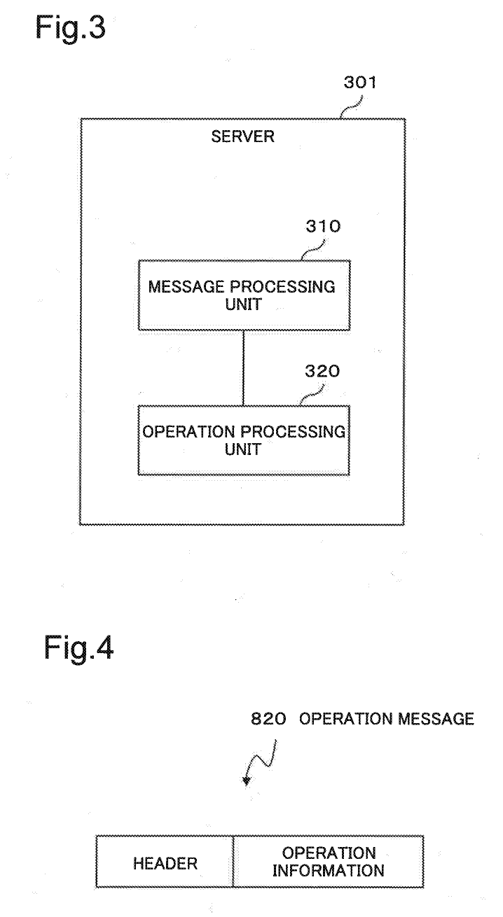

The message processing unit 310 and the operation processing unit 320 may be loaded in a server device configured to provide a virtual machine, for instance. FIG. 3 is a block diagram illustrating a configuration of a server 301, which is a server including the message processing unit 310 and the operation processing unit 320 in the example embodiment.

The operation unit 210 outputs a signal based on an operation of a user. The operation unit 210 is a physical press button, for instance. Note that the operation unit 210 may be arbitrary operation means configured to output at least an on/off signal. For instance, the operation unit 210 may be a touch screen.

The operation notifying unit 220 generates first operation information indicating a content of an operation that is performed with respect to the operation unit 210, based on a signal to be output from the operation unit 210. Further, the operation notifying unit 220 generates an operation message by appending, to the first operation information, a header addressed to the server 301 configured to provide a virtual machine (not illustrated). For instance, the address is an identifier of an interface card (not illustrated) to be mounted in the server 301. Further, the header includes transmission source information.

The operation notifying unit 220 transmits the operation message to a network (not illustrated). The network is a network configured to connect between the operation notifying unit 220 and the message processing unit 310. In other words, the network connects between the remote terminal 201 and the server 301. The network may be an IP (Internet Protocol) network, a wireless LAN, or another network.

FIG. 4 is a diagram illustrating an example of an operation message in the example embodiment. As illustrated in FIG. 4, an operation message 820 includes a header and first operation information.

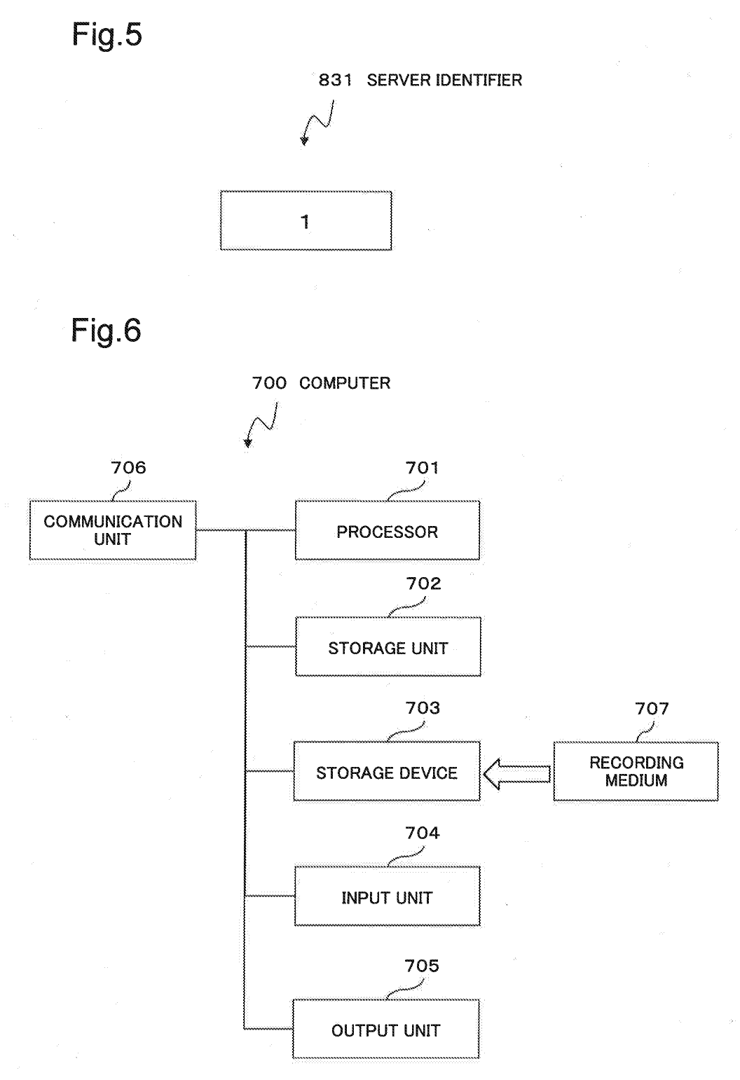

FIG. 5 is a diagram illustrating an example of a server identifier in the example embodiment. A server identifier 831 is, for instance, an identifier of an interface card of the server 301 as an address.

The message processing unit 310 generates second operation information based on the operation message 820. Second operation information is information indicating that an operation indicated by the first operation information is performed with respect to a virtual machine associated with the remote terminal 201 that transmits the operation message 820.

Specifically, firstly, the message processing unit 310 separates the operation message 820 into a header and first operation information. Secondly, the message processing unit 310 specifies the remote terminal 201 that transmits the operation message 820, based on transmission source information included in the header. Thirdly, the message processing unit 310 generates second operation information including identification information indicating the specified remote terminal 201 (e.g. a terminal number), and the first operation information.

The operation processing unit 320 operates a virtual machine associated with the remote terminal 201, based on the second operation information.

Specifically, the operation processing unit 320 determines an instruction (an instruction on an action) with respect to a virtual machine, based on first operation information included in the second operation information. Next, the operation processing unit 320 outputs a determined instruction to a virtual machine associated with the remote terminal 201 to be specified by identification information included in the second operation information.

Next, components as hardware units in a case where the example embodiment is implemented by a computer are described.

FIG. 6 is a diagram illustrating a hardware configuration of a computer 700 configured to implement each of the remote terminal 201 and the server 301 in the example embodiment.

As illustrated in FIG. 6, the computer 700 includes a processor 701, a storage unit 702, a storage device 703, an input unit 704, an output unit 705, and a communication unit 706. Further, the computer 700 includes a recording medium (or a storage medium) 707 to be supplied from the outside. For instance, the recording medium 707 is a non-volatile recording medium (a non-transitory recording medium) configured to non-transitorily store information. Further, the recording medium 707 may be a transitory recording medium configured to store information as a signal.

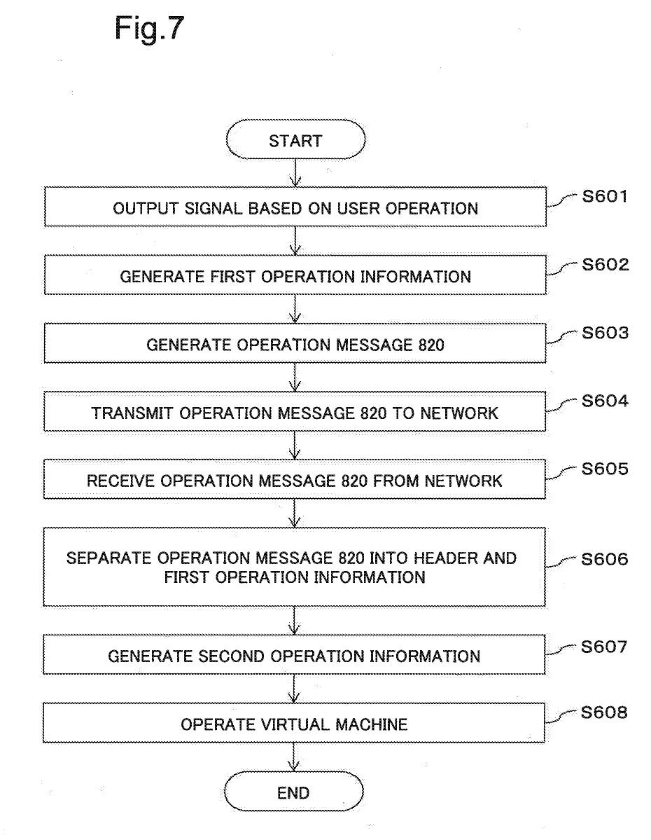

The processor 701 controls an overall operation of the computer 700 by operating an operating system (not illustrated). For instance, the processor 701 reads a program or data from the recording medium 707 mounted in the storage device 703, and writes a read program or data into the storage unit 702. In this example, the program is, for instance, a program configured to cause the computer 700 to execute an operation of the flowchart illustrated in FIG. 7 to be described later.

Further, the processor 701 executes various processes as the operation unit 201 and the operation notifying unit 220 illustrated in FIG. 2, or as the message processing unit 310 and the operation processing unit 320 illustrated in FIG. 3 according to a read program, or based on read data.

Note that the processor 701 may download the program or the data into the storage unit 702 from an external computer (not illustrated) to be connected to a communication network (not illustrated).

The storage unit 702 stores the program or the data. The storage unit 702 may store the operation message 820 or the server identifier 831. The storage unit 702 may be included as a part of the operation notifying unit 220 illustrated in FIG. 2 in the remote terminal 201. Further, the storage unit 702 may be included as a part of the message processing unit 310 and the operation processing unit 320 illustrated in FIG. 3 in the server 301.

The storage device 703 is, for instance, an optical disc, a flexible disk, a magneto-optical disk, an external hard disk semiconductor memory, or the like, and includes the recording medium 707. The storage device 703 (the recording medium 707) stores the program in a computer-readable manner. The storage device 703 may store the operation message 820, the server identifier 831, or the like. The storage device 703 may be included as a part of the operation notifying unit 220 illustrated in FIG. 2 in the remote terminal 201. Further, the storage device 703 may be included as a part of the message processing unit 310 and the operation processing unit 320 illustrated in FIG. 3 in the server 301.

The input unit 704 receives an operation input from an operator or an information input from the outside. A device for use in an input operation is, for instance, a mouse, a keyboard, a built-in key button, a touch panel, or the like. The operation unit 210 illustrated in FIG. 2 may be a part of the input unit 704. The input unit 704 may be included as a part of the operation notifying unit 220 illustrated in FIG. 2 in the remote terminal 201. Further, the input unit 704 may be included as a part of the message processing unit 310 and the operation processing unit 320 illustrated in FIG. 3 in the server 301.

The output unit 705 is implemented by a display, for instance. The output unit 705 is used, for instance, for an input request to an operator by a GUI (Graphical User Interface), or for presentation to an operator. The output unit 705 may be included as a part of the operation notifying unit 220 illustrated in FIG. 2 in the remote terminal 201. Further, the output unit 705 may be included as a part of the message processing unit 310 and the operation processing unit 320 illustrated in FIG. 3 in the server 301.

The communication unit 706 implements communication with another device. The communication unit 706 may be included as a part of the operation notifying unit 220 in the remote terminal 201. Further, the communication unit 706 may be included as a part of the message processing unit 310 in the server 301.

As described above, components as functional units of the remote terminal 201 illustrated in FIG. 2 and the server 301 illustrated in FIG. 3 may be implemented by the computer 700 having a hardware configuration illustrated in FIG. 6. Note that means configured to implement the respective units provided in the computer 700 is not limited to the above. Specifically, the computer 700 may be implemented by a physically unified device, or may be implemented by physically separated two or more devices wiredly or wirelessly connected to each other.

Note that in a case where the recording medium 707 having codes of the program recorded therein is supplied to the computer 700, the processor 701 may read and execute the codes of the program stored in the recording medium 707. Alternatively, the processor 701 may store the codes of the program stored in the recording medium 707 in one or both of the storage unit 702 and the storage device 703. Specifically, the example embodiment includes an example embodiment of the recording medium 707 configured to transitorily or non-transitorily store the program (a software) to be executed by the computer 700 (the processor 701). Note that a storage medium configured to non-transitorily store information is also referred to as a non-volatile storage medium.

The foregoing is description about the components as hardware units of the computer 700 configured to implement the virtualization system 101 in the example embodiment.

Next, an operation of the example embodiment is described in detail with reference to the drawings.

FIG. 7 is a flowchart illustrating an operation of the example embodiment. Note that a process by the flowchart may be executed based on program control by the processor 701. Further, step names of processes are described by symbols like S601.

The virtualization system 101 starts an operation of the flowchart illustrated in FIG. 7 in response to an operation of a user of the operation unit 210 in the remote terminal 201.

The operation unit 210 outputs a signal based on an operation of a user (Step S601). For instance, the operation unit 210 outputs “1” during a time when a specific button is pressed (operated). Further, the operation unit 210 outputs “0” during a time when the button is not pressed.

Next, the operation notifying unit 220 generates first operation information indicating a time during which a specific button of the operation unit 210 is pressed, based on a signal to be output from the operation unit 210 (Step S602).

Next, the operation notifying unit 220 generates an operation message 820 including generated first operation information, and addressed to the server 301 (Step S603). For instance, the address may be stored in advance in the storage unit 702 or in the storage device 703 illustrated in FIG. 6. Further, the operation notifying unit 220 may acquire an address input by an operator via the input unit 704 illustrated in FIG. 6. Further, the operation notifying unit 220 may receive an address from an unillustrated device via the communication unit 706 illustrated in FIG. 6. Further, the operation notifying unit 220 may acquire an address recorded in the recording medium 707 via the storage device 703 illustrated in FIG. 6.

Next, the operation notifying unit 220 transmits the generated operation message 820 to a network (Step S604).

Next, the message processing unit 310 receives the operation message 820 via the network (Step S605).

Next, the message processing unit 310 separates the operation message 820 into a header and first operation information (Step S606).

Next, the message processing unit 310 generates and transmits second operation information including the first operation information based on a header (Step S607).

Next, the operation processing unit 320 operates a virtual machine based on the second operation information (Step S608).

An advantageous effect in the example embodiment is that a user is allowed to control the virtualization system 101 without wasting resources.

The reason for this is because the example embodiment includes the following configuration. Specifically, firstly, the operation notifying unit 220 transmits the operation message 820 obtained by appending, to first operation information indicating a content of an operation that is performed with respect to the operation unit 210, a header addressed to a server configured to provide a virtual machine. Secondly, the message processing unit 310 generates second operation information indicating that an operation indicated by first operation information is performed with respect to a virtual machine associated with a transmission source of the operation message 820, based on the operation message 820. Thirdly, the operation processing unit 320 instructs the virtual machine to perform an action associated with the operation, based on the second operation information.

### First Modification Example of First Example Embodiment

In the modification example, an operation notifying unit 220 further generates second operation information from first operation information.

Specifically, the operation notifying unit 220 generates second operation information including identification information indicating a remote terminal 201, and first operation information. For instance, identification information may be stored in advance in the storage unit 702 or in the storage device 703 illustrated in FIG. 6. Further, the operation notifying unit 220 may acquire identification information input from an operator via the input unit 704 illustrated in FIG. 6. Further, the operation notifying unit 220 may receive identification information from an unillustrated device via the communication unit 706 illustrated in FIG. 6. Further, the operation notifying unit 220 may acquire identification information recorded in a recording medium 707 via the storage device 703 illustrated in FIG. 6.

Next, the operation notifying unit 220 transmits an operation message 820 including second operation information to a network.

Further, in the modification example, a message processing unit 310 uses second operation information included in the received operation message 820 as it is, based on the premise that the message processing unit 310 itself generates the second operation information.

Specifically, in the modification example, the operation notifying unit 220 executes an operation of specifying a remote terminal 201 that transmits the operation message 820, and an operation of generating second operation information, in place of the message processing unit 310. These operations are executed by the message processing unit 310 in the first example embodiment.

The modification example makes it possible to avoid concentration of load in the message processing unit 310 (specifically, a server 301) by performing the aforementioned operation.

### Second Modification Example of First Example Embodiment

In the modification example, an operation notifying unit 220 generates first operation information indicating an instruction to a virtual machine, which is generated based on a signal to be output from an operation unit 210 and is associated with a time during which an operation unit 210 is pressed.

Further, in the modification example, an operation processing unit 320 outputs first operation information included in second operation information to a virtual machine associated with a remote terminal 201 which is specified by identification information included in the second operation information.

Specifically, in the modification example, the operation notifying unit 220 executes an operation of determining an instruction to a virtual machine, in place of the operation processing unit 320.

The modification example makes it possible to avoid concentration of load to the operation processing unit 320 (specifically, a server 301) by performing the aforementioned operation.

### Second Example Embodiment

Next, the second example embodiment of the present invention is described in detail with reference to the drawings. In the following, description of the example embodiment regarding the content that overlaps the aforementioned description is omitted, as far as as the description of the example embodiment remains clear.

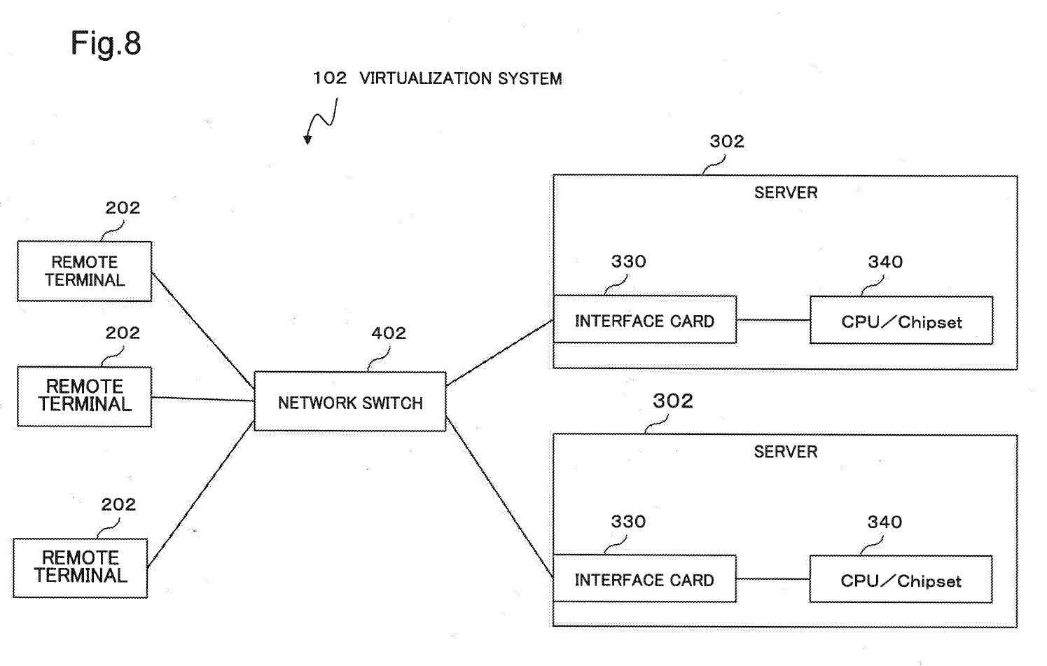

FIG. 8 is a block diagram illustrating a configuration of a virtualization system 102 according to the second example embodiment of the present invention.

As illustrated in FIG. 8, the virtualization system 102 includes remote terminals 202, servers 302, and a network switch 402. The numbers of remote terminals 202, servers 302, and network switches 402 included in the virtualization system 102 are not limited to specific numbers, regardless of the example illustrated in FIG. 8.

The remote terminal 202 is a terminal to be used when a user operates a virtual machine.

The server 302 is a server on which a virtualization software (details thereof are described later) is operated, and is a server configured to provide a virtual machine.

The network switch 402 is a device configured to perform forwarding and routing between a plurality of interface cards 330 and remote terminals 202. The network switch 402 is a well-known device, and therefore, detailed description thereof is omitted.

Next, the remote terminal 202 is described in detail.

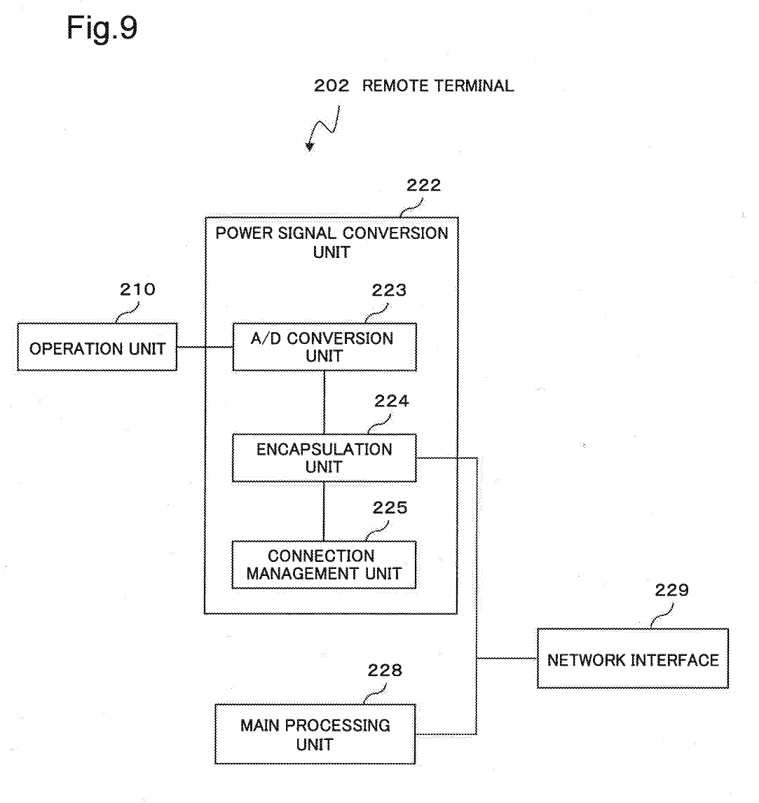

FIG. 9 is a block diagram illustrating a configuration of the remote terminal 202. As illustrated in FIG. 9, the remote terminal 202 includes an operation unit 210, a power signal conversion unit 222, a main processing unit 228, and a network interface 229. The operation unit 210 includes a power button.

Each component illustrated in FIG. 9 may be circuitry as a hardware unit, a module included in a microchip, or components divided as a functional unit of a computer device. In this example, description is made based on the premise that the components illustrated in FIG. 9 are components divided as functional units of a computer device.

The power signal conversion unit 222 generates an operation message 820 including first operation information indicating a content of an operation that is performed with respect to the operation unit 210, based on a signal to be output from the operation unit 210, and transmits the generated operation message 820 to a network via the network interface 229. The power signal conversion unit 222 includes an A/D conversion unit 223, an encapsulation unit 224, and a connection management unit 225.

The A/D conversion unit 223 converts a signal to be output from the operation unit 210 (in this example, an analog pulse of an ON/OFF state) into digital information (in this example, information indicating a time during which the signal is in an ON-state), and generates first operation information.

The encapsulation unit 224 generates the operation message 820 by encapsulating first operation information by using a server 302 to be determined by the connection management unit 225 as an address, and outputs the generated operation message 820.

The connection management unit 225 stores a server identifier 831 configured to specify the server 302, and outputs the server identifier 831 to the encapsulation unit 224 as an address of the operation message 820.

The main processing unit 228 is a main functional operation unit as a terminal of a virtual machine in a remote terminal 202. The technique relating to the main processing unit 228 is a well-known technique, and therefore, detailed description thereof is omitted.

The network interface 229 communicates with the server 302. The technique relating to the network interface 229 is a well-known technique, and therefore, detailed description thereof is omitted.

The remote terminal 202 may be implemented by the computer 700 illustrated in FIG. 6 as well as the remote terminal 201.

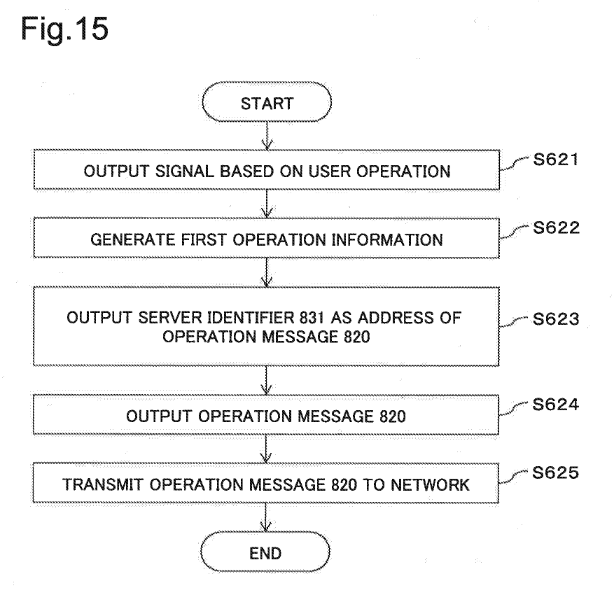

In this case, a processor 701 executes various processes as the power signal conversion unit 222, the main processing unit 228, and the network interface 229 according to a read program, or based on read data. In this example, the program is a program configured to cause the computer 700 to execute an operation of the flowchart illustrated in FIG. 15 to be described later, for instance.

A storage unit 702 may store the server identifier 831, and other information. The storage unit 702 may be included as a part of the connection management unit 225 and the other components illustrated in FIG. 9.

A storage device 703 may store the server identifier 831 and other information. The storage device 703 may be included as a part of the connection management unit 225 and the other components illustrated in FIG. 9.

A communication unit 706 may be included as a part of the network interface 229.

The foregoing is detailed description about the remote terminal 202.

Next, the server 302 is described in detail.

As illustrated in FIG. 8, the server 302 includes an interface card 330 and a CPU (Central Processing Unit)/Chipset 340.

The interface card 330 is a board on which an interface for use in communication with the remote terminal 202 is loaded. The interface card 330 includes an intrinsic identifier (the server identifier 831 in the example embodiment). Each of the remote terminals 202 is connected to the interface card 330 having the server identifier 831 to be stored by each of the remote terminals 202.

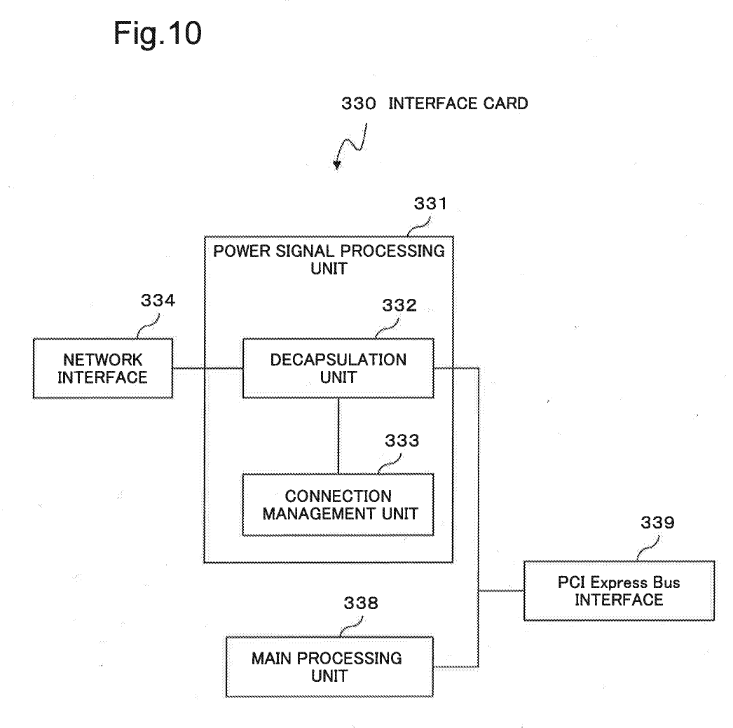

FIG. 10 is a block diagram illustrating a configuration of the interface card 330. As illustrated in FIG. 10, the interface card 330 includes a power signal processing unit 331, a network interface 334, a main processing unit 338, and a PCI (Peripheral Component Interconnect) Express (registered trademark) Bus interface 339.

The power signal processing unit 331 receives the operation message 820, and generates second operation information based on the operation message 820. Further, the power signal processing unit 331 transmits generated second operation information to the CPU/Chipset 340 via the PCI Express Bus interface 339.

The power signal processing unit 331 includes a decapsulation unit 332 and a connection management unit 333.

The decapsulation unit 332 separates the received operation message 820 into a header and first operation information.

Next, the decapsulation unit 332 encapsulates the first operation information with use of a PCI Express header to be output from the connection management unit 333, and generates second operation information.

Next, the decapsulation unit 332 transmits the second operation information to the CPU/Chipset 340 via the PCI Express Bus interface 339.

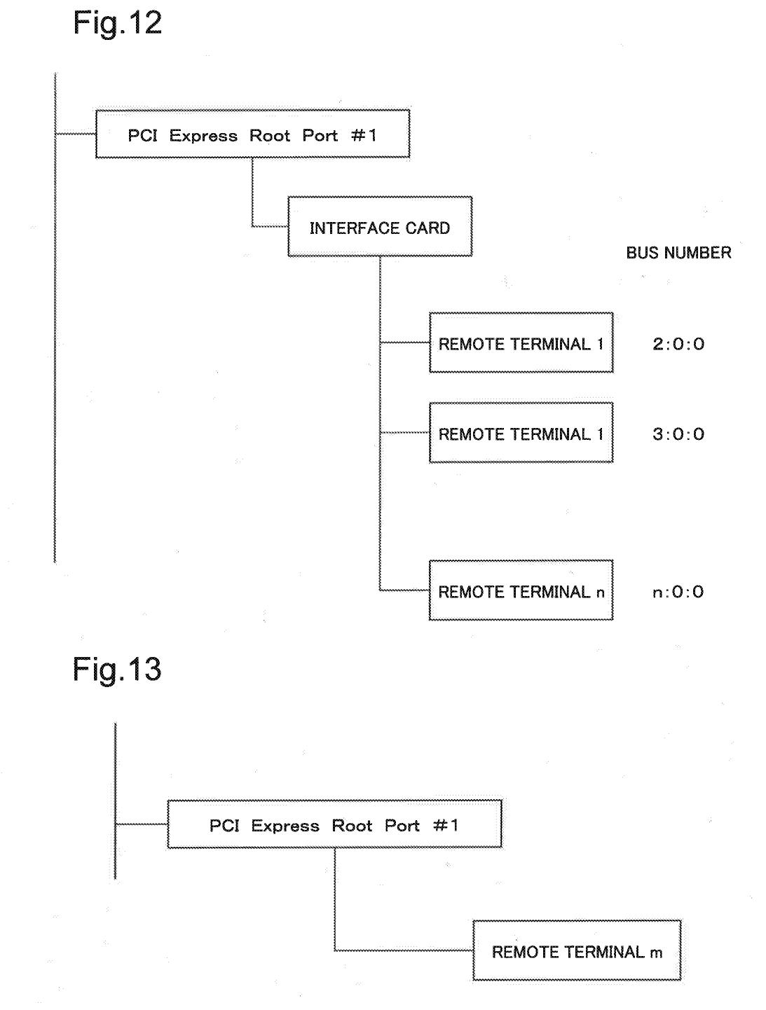

The connection management unit 333 specifies the remote terminal 202 as a transmission source, based on information of the remote terminal 202 as a transmission source included in a header, and virtualization information of the remote terminal 202. Next, the connection management unit 333 generates a PCI Express header associated with the remote terminal 202 as a transmission source, and outputs the PCI Express header to the decapsulation unit 332. Virtualization information is information including a bus number of the remote terminal 202, as illustrated in FIG. 12 to be described later.

The main processing unit 338 processes communication with the main processing unit 228 of the remote terminal 202. The technique relating to the main processing unit 338 is a well-known technique, and therefore, detailed description thereof is omitted.

The network interface 334 performs communication with the remote terminal 202. The technique relating to the network interface 334 is a well-known technique, and therefore, detailed description thereof is omitted.

The PCI Express Bus interface 339 controls communication with the CPU/Chipset 340. The technique relating to the PCI Express Bus interface 339 is a well-known technique, and therefore, detailed description thereof is omitted.

The CPU/Chipset 340 activates a virtualization software, and provides a virtual machine. The technique relating to the CPU/Chipset 340 is a well-known technique, and therefore, detailed description thereof is omitted.

Next, a virtualization configuration of the virtualization system 102 is described.

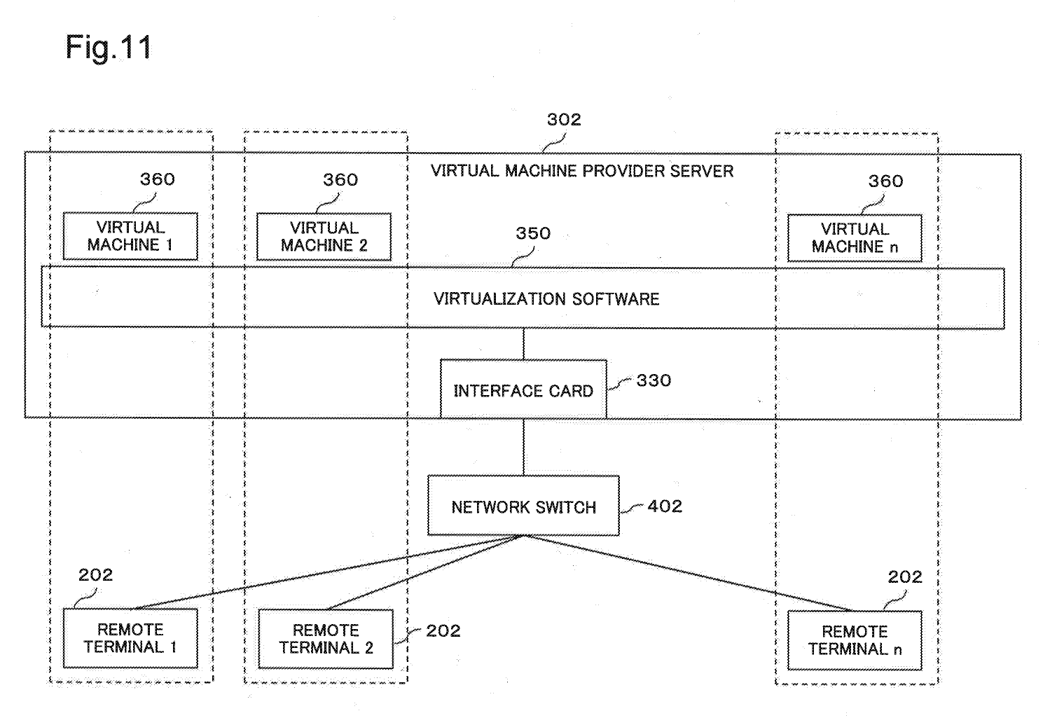

FIG. 11 is a block diagram illustrating a virtualization configuration of the virtualization system 102. The server 302 may include a virtual machine 360, regardless of the example of FIG. 11. Further, the virtualization system 102 may include an arbitrary number of remote terminals 202.

As illustrated in FIG. 11, the virtual machine 360 is configured on a virtualization software 350.

The virtualization software 350 handles each remote terminal 202 as a PCI Express device. Specifically, in the server 302, each remote terminal 202 is managed by a PCI bus tree, and an intrinsic bus number is given to each remote terminal 202. FIG. 12 is a diagram illustrating an example of the PCI bus tree of the server 302. The technique relating to the PCI bus tree is a well-known technique, and therefore, detailed description thereof is omitted.

The virtualization software 350 associates each of the virtual machines 360 and each of the remote terminals 202 with an intrinsic bus number. Specifically, in a PCI bus tree of each of the virtual machines 360, the virtual machine 360 and the remote terminal 202 are directly connected to each other. FIG. 13 is a diagram illustrating an example of the PCI bus tree of the virtual machine 360.

Next, the virtualization software 350 and the virtual machine 360 are described in detail.

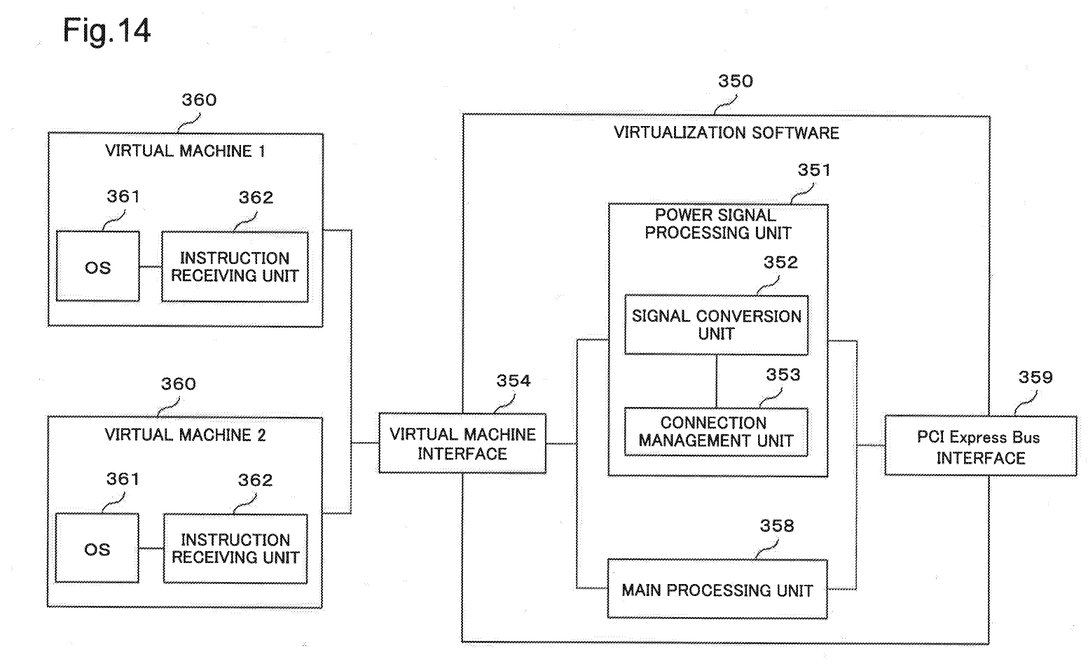

FIG. 14 is a block diagram illustrating a configuration of the virtualization software 350 and the virtual machine 360.

As illustrated in FIG. 14, the virtualization software 350 includes a power signal processing unit 351, a virtual machine interface 354, a main processing unit 358, and a PCI Express Bus interface 359. The number of virtual machines 360 is not limited to a specific number, regardless of the example illustrated in FIG. 14.

The power signal processing unit 351 includes a signal conversion unit 352 and a connection management unit 353.

The signal conversion unit 352 receives second operation information via the PCI Express Bus interface 359.

Next, the connection management unit 353 refers to correspondence information between second operation information, the remote terminals 202, and the virtual machines 360, and determines a virtual machine 360 that outputs an instruction. For instance, the correspondence information is information for designating a remote terminal 202 based on a PCI bus tree of a virtual machine 360 as illustrated in FIG. 13.

Next, the signal conversion unit 352 determines an operation to be instructed to the virtual machine 360, based on first operation information included in the second operation information. For instance, when the signal conversion unit 352 analyzes the first operation information and detects that the operation unit 210 is pressed for a time shorter than a predetermined time, the signal conversion unit 352 determines “shut down” in a power-on state of a virtual machine 360 that outputs the instruction. Further, when the signal conversion unit 352 detects that the operation unit 210 is pressed for a time shorter than a predetermined time, and a virtual machine 360 that outputs the instruction is in a power-off state, the signal conversion unit 352 determines that the power is in an ON-state. Further, when the signal conversion unit 352 detects that the operation unit 210 is pressed for a predetermined time or longer, the signal conversion unit 352 determines “forced shut down”.

Next, the signal conversion unit 352 outputs an instruction on the determined operation to a determined virtual machine 360 via the virtual machine interface 354.

The virtual machine interface 354 controls communication between the virtualization software 350 and the virtual machine 360. The technique relating to the virtual machine interface 354 is a well-known technique, and therefore, detailed description thereof is omitted.

The main processing unit 358 controls communication between the virtual machine 360 and the main processing unit 228 of the remote terminal 202. The technique relating to the main processing unit 358 is a well-known technique, and therefore, detailed description thereof is omitted.

The PCI Express Bus interface 359 controls communication with the interface card 330. The technique relating to the PCI Express Bus interface 359 is a well-known technique, and therefore, detailed description thereof is omitted.

As illustrated in FIG. 14, the virtual machine 360 includes an OS 361 and an instruction receiving unit 362. The instruction receiving unit 362 executes an operation designated in association with an OS 361, based on an instruction to be output from the virtualization software 350. The technique relating to the OS 361 and the instruction receiving unit 362 is a well-known technique, and therefore, detailed description thereof is omitted.

The server 302 may be implemented by the computer 700 illustrated in FIG. 6, as well as the server 301.

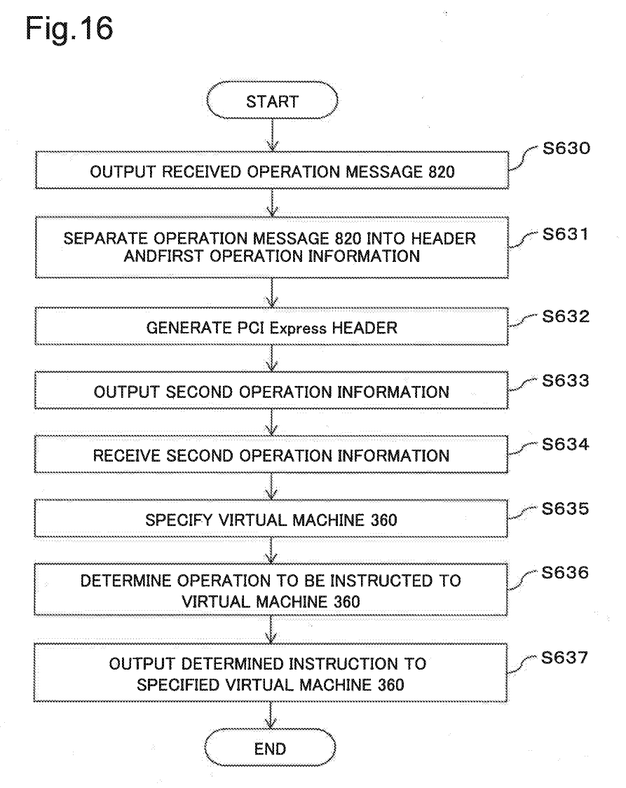

In this case, the processor 701 corresponds to the CPU/Chipset 340. The processor 701 executes various processes further as the virtualization software 350 and the virtual machine 360 illustrated in FIG. 14 according to the read program, or based on the read data. In this example, the program is, for instance, a program that causes the computer 700 to execute an operation of the flowchart illustrated in FIG. 16 to be described later.

The storage unit 702 may store correspondence information between the remote terminal 202 and the virtual machine 360, or other information, for instance.

The storage device 703 may store correspondence information between the remote terminal 202 and the virtual machine 360, or other information, for instance.

Further, the communication unit 706 corresponds to the interface card 330.

The foregoing is detailed description about the server 302.

Next, an operation of the example embodiment is described in detail with reference to the drawings.

FIG. 15 is a flowchart illustrating an operation of the remote terminal 202 in the example embodiment. Note that a process by the flowchart may be executed, based on program control by the processor 701 described above. Further, step names of processes are described as symbols like S601.

The virtualization system 102 starts an operation of the flowchart illustrated in FIG. 15 in response to an operation of a user of the operation unit 210 in the remote terminal 202.

The operation unit 210 outputs a signal based on an operation of a user (Step S621).

Next, the A/D conversion unit 223 of the power signal conversion unit 222 receives a signal to be output from the operation unit 210, and converts the received signal into digital information to generate first operation information (Step S622).

Next, the connection management unit 225 of the power signal conversion unit 222 outputs the server identifier 831 to the encapsulation unit 224 as an address of the operation message 820 (Step S623).

Next, the encapsulation unit 224 of the power signal conversion unit 222 encapsulates first operation information by using the server identifier 831 received from the connection management unit 225 as an address to generate the operation message 820, and outputs the operation message 820 (Step S624).

Next, the network interface 229 transmits the operation message 820 to a network (Step S625).

FIG. 16 is a flowchart illustrating an operation of the server 302 in the example embodiment. Note that a process by the flowchart may be executed, based on program control by the processor 701 described above. Further, step names of processes are described by symbols like S601.

The server 301 starts an operation of the flowchart illustrated in FIG. 16 in response to receiving the operation message 820.

The network interface 334 of the interface card 330 outputs the received operation message 820 to the power signal processing unit 331 (Step S630).

Next, the decapsulation unit 332 of the power signal processing unit 331 of the interface card 330 separates the operation message 820 into a header and first operation information (Step S631).

Next, the connection management unit 333 analyzes the header to specify the remote terminal 202 as a transmission source, and generates a PCI Express header associated with the remote terminal 202 (Step S632). For instance, the connection management unit 333 generates a PCI Express header including a bus number given to the remote terminal 202.

Next, the decapsulation unit 332 appends the PCI Express header to the first operation information, and outputs the appended information as second operation information via the PCI Express Bus interface 339 (Step S633).

Next, the power signal processing unit 351 of the virtualization software 350 receives the second operation information via the PCI Express Bus interface 359 (Step S634).

Next, the connection management unit 353 of the power signal processing unit 351 specifies the virtual machine 360, based on a bus number included in a PCI Express header of the second operation information (Step S635). Note that the connection management unit 353 may specify the virtual machine 360, based on a memory address included in a PCI Express header of the second operation information.

Next, the signal conversion unit 352 analyzes first operation information included in the second operation information, and determines an operation to be instructed to the virtual machine 360 (Step S636).

Next, the signal conversion unit 352 outputs an instruction determined in Step S636 to the virtual machine 360 specified in Step S635 (Step S637).

An advantageous effect in the example embodiment described above is that the user is allowed to control the virtualization system 102 without wasting resources as well as the first example embodiment.

The reason for this is because the example embodiment includes the following configuration. Specifically, firstly, the power signal conversion unit 222 of the remote terminal 202 transmits the operation message 820 including first operation information. Secondly, the interface card 330 of the server 302 and the virtualization software 350 operate the virtual machine 360 based on the operation message 820.

### Modification Example of Second Example Embodiment

In the second example embodiment, the virtualization system 102 may employ the first and second modification examples of the first example embodiment described above.

Components described in the aforementioned example embodiments may not be necessarily individually independent elements. For instance, an arbitrary plurality of components may be implemented as a module. Further, an arbitrary one of components may be implemented by a plurality of modules. Further, an arbitrary one of components may be another arbitrary one of the components. Further, a part of an arbitrary one of the components may overlap a part of another arbitrary one of the components.

Respective components, and a module configured to implement the respective components in the example embodiments described above may be implemented as a hardware unit as necessary and if possible. Further, respective components and a module configured to implement the respective components may be implemented by a computer and a program. Further, respective components and a module configured to implement the respective components may be implemented by combination of a module as a hardware unit, a computer, and a program.

The program is recorded in a computer-readable non-transitory recording medium such as a magnetic disk or a semiconductor memory, for instance, and is provided for a computer. Further, the program is read by a computer from a non-transitory recording medium when the computer is activated, or the like. The read program causes the computer to function as the components in the example embodiments described above by controlling an operation of the computer.

Further, in the example embodiments described above, a plurality of operations are described in an order in the form of a flowchart. The order of description does not limit the order in which a plurality of operations are executed. Therefore, it is possible to modify the order of the plurality of operations as long as there is no difficulty in the contents in implementing the example embodiments.

Further, in the example embodiments described above, a plurality of operations may not be executed at individually different timings. For instance, during execution of a certain operation, another operation may be executed. Further, execution timings of a certain operation and another operation may partially or entirely overlap each other.

Further, in the example embodiments described above, another operation is triggered by a certain operation. The description does not limit a relationship between a certain operation and another operation. Therefore, it is possible to modify the relationship between the plurality of operations as long as there is no difficulty in the contents in implementing the example embodiments. Further, specific description of operations of components does not limit operations of components. Therefore, specific operations of components may be modified as long as there is no difficulty in terms of functions, performances, and the other characteristics in implementing the example embodiments.

A part or the entirety of the example embodiments may be described as the following Supplemental notes, but are not limited to the following.

(Supplemental note 1)

A virtualization system including:

an operation unit configured to output a signal based on an operation of a user;

an operation notifying unit configured to transmit, to a network, an operation message generated by appending a header addressed to a server configured to provide a virtual machine for first operation information indicating a content of the operation associated with the output signal;

a message processing unit configured to generate second operation information indicating that the operation is performed with respect to the virtual machine associated with a transmission source of the operation message, based on the operation message; and

an operation processing unit configured to instruct an action associated with the operation to the virtual machine associated with the transmission source, based on the second operation information.

(Supplemental note 2)

The virtualization system according to Supplemental note 1, wherein

the operation notifying unit generates the second operation information in place of the message processing means, and generates the operation message by appending the header to the second operation information.

(Supplemental note 3)

The device according to Supplemental note 1 or 2, wherein the operation notifying unit generates information indicating a change in a signal to be output from the operation unit, as the first operation information.

(Supplemental note 4)

The virtualization system according to Supplemental note 1 or 2, wherein

the operation notifying unit generates information indicating an instruction to the virtual machine associated with a change in a signal to be output from the operation unit, as the first operation information.

(Supplemental note 5)

The virtualization system according to any one of Supplemental notes 1, 3, and 4, wherein

the operation unit is loaded in a terminal,

the message processing unit sets the terminal as a PCI (Peripheral Component Interconnect) Express device and generates the second operation information, and

the operation processing unit sets the terminal as a PCI Express device, and instructs an action associated with the operation to the virtual machine associated with the transmission source.

(Supplemental note 6)

A terminal including:

an operation unit configured to output a signal based on an operation of a user; and

an operation notifying unit configured to transmit, to a network, an operation message generated by appending a header addressed to a server configured to provide the virtual machine for first operation information indicating a content of the operation associated with the output signal, wherein

the server generates second operation information indicating that an operation indicated by the first operation information is performed with respect to the virtual machine associated with a transmission source of the operation message, based on the operation message, and instructs an action associated with the operation to the virtual machine associated with the transmission source, based on the second operation information.

(Supplemental note 7)

A server including:

a message processing unit configured to generate second operation information indicating that an operation indicated by first operation information is performed with respect to a virtual machine associated with a terminal, based on an operation message to be transmitted from the terminal; and

an operation processing unit configured to instruct an action associated with the operation to the virtual machine associated with the terminal, based on the second operation information, wherein

the terminal transmits, to a network, an operation message generated by appending a header addressed to a server configured to provide the virtual machine for first operation information indicating a content of the operation associated with a signal to be output from operation means based on an operation of a user.

(Supplemental note 8)

A virtualization method including:

outputting a signal based on an operation of a user;

generating an operation message by appending a header addressed to a server configured to provide a virtual machine for first operation information indicating a content of the operation associated with the signal;

transmitting the operation message to a network;

generating second operation information indicating that an operation indicated by the first operation information is performed with respect to the virtual machine associated with a transmission source of the operation message, based on the operation message; and

instructing an action associated with the operation to the virtual machine associated with the transmission source, based on the second operation information.

(Supplemental note 9)

A program that causes a computer to execute:

a process of generating an operation message by appending a header addressed to a server configured to provide a virtual machine for first operation information indicating a content of an operation of a user associated with a signal output based on the operation; and

a process of transmitting the operation message to a network, wherein

the server generates second operation information indicating that the operation is performed with respect to the virtual machine associated with a transmission source of the operation message, based on the operation message, and instructs an action associated with the operation to the virtual machine associated with the transmission source, based on the second operation information.

(Supplemental note 10)

A program that causes a computer to execute:

a process of generating second operation information indicating that an operation indicated by first operation information is performed with respect to a virtual machine associated with a terminal, based on an operation message to be transmitted from the terminal; and

a process of instructing an action associated with the operation to the virtual machine associated with the terminal, based on the second operation information, wherein

the terminal generates an operation message by appending a header addressed to a server configured to provide the virtual machine for first operation information indicating a content of the operation associated with a signal to be output from an operation unit, based on an operation of a user, and transmits the operation message to a network.

(Supplemental note 11)

A virtualization method including:

generating an operation message by appending a header addressed to a server configured to provide a virtual machine for first operation information indicating a content of an operation of a user associated with a signal output based on the operation;

transmitting the operation message to a network; and

generating second operation information indicating that the operation is performed with respect to the virtual machine associated with a transmission source of the operation message, based on the operation message, and instructing an action associated with the operation to the virtual machine associated with the transmission source, based on the second operation information.

(Supplemental note 12)

A virtualization method including:

generating second operation information indicating that an operation indicated by first operation information is performed with respect to a virtual machine associated with a terminal, based on an operation message to be transmitted from the terminal;

instructing an action associated with the operation to the virtual machine associated with the terminal, based on the second operation information;

generating an operation message by appending a header addressed to a server configured to provide the virtual machine for first operation information indicating a content of the operation associated with a signal to be output from an operation unit, based on an operation of a user; and

transmitting the operation message to a network.

In the aforementioned description, the present invention is described with reference to the example embodiments. The present invention, however, is not limited to the aforementioned example embodiments. The configuration and details of the present invention may be modified in various ways comprehensible to a person skilled in the art within the scope of the present invention.

This application claims the priority based on Japanese Patent Application No. 2015-013169 filed on Jan. 27, 2015, entire disclosure of which is hereby incorporated.

### REFERENCE SIGNS LIST

101 Virtualization system

102 Virtualization system

201 Remote terminal

202 Remote terminal

210 Operation unit

220 Operation notifying unit

222 Power signal conversion unit

223 A/D conversion unit

224 Encapsulation unit

225 Connection management unit

228 Main processing unit

229 Network interface

301 Server

302 Server

310 Message processing unit

320 Operation processing unit

330 Interface card

331 Power signal processing unit

332 Decapsulation unit

333 Connection management unit

334 Network interface

338 Main processing unit

339 PCI Express Bus interface

340 CPU/Chipset

350 Virtualization software

351 Power signal processing unit

352 Signal conversion unit

353 Connection management unit

354 Virtual machine interface

358 Main processing unit

359 PCI Express Bus interface

360 Virtual machine

361 OS

362 Instruction receiving unit

402 Network switch

700 Computer

701 Processor

702 Storage unit

703 Storage device

704 Input unit

705 Output unit

706 Communication unit

707 Recording medium

820 Operation message

831 Server identifier

What is claimed is:

1. A virtualization system comprising circuitry configured to:
output a signal, based on an operation of a user;
transmit, to a network, an operation message generated by appending a header addressed to a server configured to provide a virtual machine for first operation information indicating a content of the operation associated with the output signal;
generate second operation information indicating that the operation is performed with respect to the virtual machine associated with a transmission source of the operation message, based on the operation message; and
instruct an action associated with the operation to the virtual machine associated with the transmission source, based on the second operation information.

2. The virtualization system according to claim 1, wherein the circuitry configured to
generate the second operation information in place of the message processing means, and generates the operation message by appending the header to the second operation information.

3. The virtualization system according to claim 1, wherein the circuitry configured to
generate information indicating a change in a signal to be output from the operation means, as the first operation information.

4. The virtualization system according to claim 1, wherein the circuitry configured to
generate information indicating an instruction to the virtual machine associated with a change in a signal to be output from the operation means, as the first operation information.

5. The virtualization system according to claim 1, further comprising a terminal configured to output the signal, wherein the circuitry configured to
set the terminal as a PCI (Peripheral Component Interconnect) Express® device and generate the second operation information, and
set the terminal as a PCI Express® device, and instruct an action associated with the operation to the virtual machine associated with the transmission source.

6-7. (canceled)

8. A virtualization method comprising:
outputting a signal, based on an operation of a user;
generating an operation message by appending a header addressed to a server configured to provide a virtual machine for first operation information indicating a content of the operation associated with the signal;
transmitting the operation message to a network;
generating second operation information indicating that the operation is performed with respect to the virtual machine associated with a transmission source of the operation message, based on the operation message; and
instructing an action associated with the operation to the virtual machine associated with the transmission source, based on the second operation information.

9. (canceled)

10. A computer-readable program recording medium recording a program causing a computer to execute:
a process of generating first operation information indicating that an operation indicated by second operation information is performed with respect to a virtual machine associated with a terminal, based on an operation message to be transmitted by the terminal; and
a process of instructing an action associated with the operation to the virtual machine associated with the terminal, based on the first operation information, wherein
the terminal generates an operation message by appending a header addressed to a server configured to provide the virtual machine for second operation information indicating a content of the operation associated with a signal to be output by operation means, based on an operation of a user, and transmits the operation message to a network.
